(19) United States
(12) Patent Application Publication
(10) Pub. No.: US 2009/0293486 A1
(43) Pub. Date: Dec. 3, 2009

(54) COMBUSTORS WITH IGNITERS HAVING PROTRUSIONS

(75) Inventors: Amy T. Hanson, Peoria, AZ (US); Ronald B. Pardington, Gilbert, AZ (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/925,347

(22) Filed: Oct. 26, 2007

(51) Int. Cl. F02C 1/00; F02C 7/264

(52) U.S. Cl. 60/752; 60/39.821

(57) ABSTRACT

A combustor for a gas turbine engine is provided, and includes an inner case; an outer case circumscribing the inner case and forming an annular pressure vessel therebetween; an inner liner positioned within the annular pressure vessel; an outer liner circumscribing the inner liner and forming a combustion chamber with the inner liner; and an igniter coupled to the outer case and extending to the outer liner such that the igniter is positioned to ignite an air and fuel mixture in the combustion chamber. The igniter includes a protrusion for coupling the igniter to the outer liner.

STATEMENT REGARDING FEDERALLY SPONSORED RESEARCH OR DEVELOPMENT

This invention was made with Government support under contract number F33615-03-D-2355-D006 of the Versatile Affordable Advanced Turbine Engines (VAATE) program awarded by US Air Force. The Government has certain rights in this invention.

### TECHNICAL FIELD

The present invention generally relates to combustors for gas turbine engines, and more particularly relates to igniters mounted to a combustion chamber of the combustors.

### BACKGROUND

Combustors are used to ignite and burn fuel and air mixtures in gas turbine engines. Known combustors are generally constructed with inner and outer liners that define an annular combustion chamber in which the fuel and air mixtures are combusted. The inner and outer liners are typically spaced radially inwardly from a combustor case such that inner and outer passageways are defined between the respective inner and outer liners and the combustor case. Fuel igniters couple to the combustor case, extend through the outer passageway, and couple to the outer liner by igniter tubes attached to the combustor liner. The igniter tubes secure and maintain the igniters in alignment relative to the combustion chamber as well as provide a sealing interface for the igniter between the outer passageway and the combustion chamber.

During operation, high temperatures in the combustion chamber cause both the combustor case and the outer liner to expand, but at different rates and in different directions. Since the igniters are coupled to both the combustor case and the liner, the igniter can be pulled in different directions, which may compromise the sealing interface between the igniter and the igniter tube mounted on the inner liner. Some igniter tubes attempt to address this issue by incorporating a grommet or other structure to allow lateral movement of the igniter. Even in such cases, however, the lateral movement is limited and is only within the plane of the grommet.

Accordingly, it is desirable to provide combustors with igniters that maintain a sealing interface with the igniter tube, particularly after expansion of the combustor case and liner. Furthermore, other desirable features and characteristics of the present invention will become apparent from the subsequent detailed description of the invention and the appended claims, taken in conjunction with the accompanying drawings and this background of the invention.

### BRIEF SUMMARY

In accordance with an exemplary embodiment, a combustor for a gas turbine engine is provided and includes an inner case; an outer case circumscribing the inner case and forming an annular pressure vessel therebetween; an inner liner positioned within the annular pressure vessel; an outer liner circumscribing the inner liner and forming a combustion chamber with the inner liner; and an igniter coupled to the outer case and extending to the outer liner such that the igniter is positioned to ignite an air and fuel mixture in the combustion chamber. The igniter includes a protrusion for coupling the igniter to the outer liner.

In accordance with another exemplary embodiment, an igniter assembly for igniting an air and fuel mixture in a combustion chamber of a combustor is provided and includes an igniter tube configured to be mounted on a liner of the combustion chamber; and an igniter. The igniter includes a generally cylindrical body having a first end and a second end, and a protrusion extending from the cylindrical body adjacent the first end and coupled to the igniter tube.

In accordance with yet another exemplary embodiment, a combustor for a gas turbine engine is provided and includes an inner case; an outer case circumscribing the inner case and forming an annular pressure vessel therebetween, with the outer case thermally expanding in a first direction during operation; an inner liner positioned within the annular pressure vessel; an outer liner circumscribing the inner liner and forming a combustion chamber with the inner liner, with the outer liner thermally expanding in a second direction during operation; and an igniter for igniting an air and fuel mixture in the combustion chamber. The igniter having body coupled to the outer case and extending to the outer liner, and the igniter further includes a cylindrical protrusion extending from the body and coupled to the outer liner such that the igniter pivots at the protrusion when the outer case moves in a first direction and the inner case moves in the second direction.

### BRIEF DESCRIPTION OF THE DRAWINGS

The present invention will hereinafter be described in conjunction with the following drawing figures, wherein like numerals denote like elements, and wherein:

FIG. 1 is a cross-sectional view of a combustor for a gas turbine engine in accordance with an exemplary embodiment; and

FIG. 2 is an enlarged isometric cross-sectional view of an igniter suitable for use in the combustor of FIG. 1 in accordance with an exemplary embodiment of the present invention.

### DETAILED DESCRIPTION

The following detailed description is merely exemplary in nature and is not intended to limit the described embodiments or the application and uses of the described embodiments. Furthermore, there is no intention to be bound by any theory presented in the preceding background or the following detailed description.

In accordance with an exemplary embodiment and as further described below, combustors are provided with igniters having protrusions that couple the igniters to liners of combustion chambers such that the igniters can accommodate relative movement of the components of the combustor.

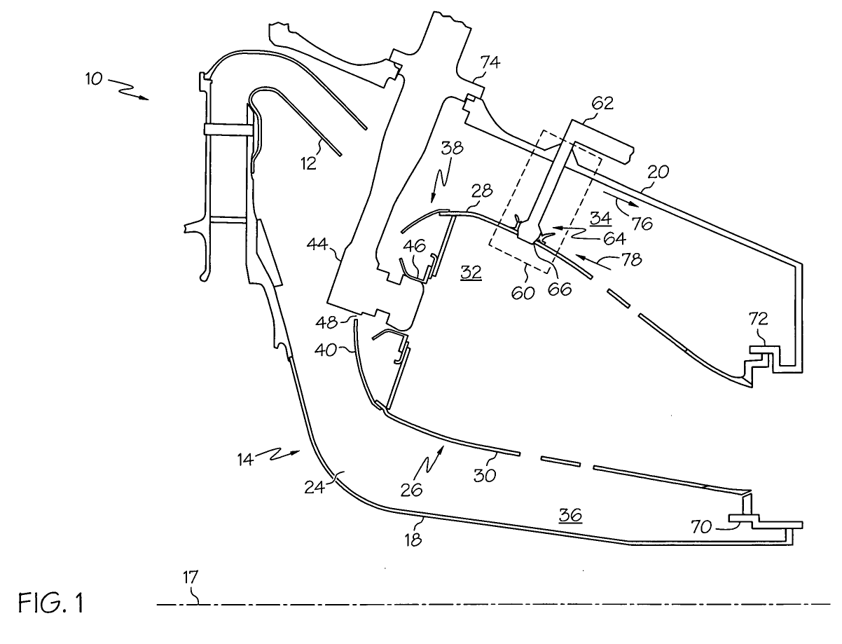

FIG. 1 is a cross-sectional view of a combustor 14 for a gas turbine engine in accordance with an exemplary embodiment. Although the depicted combustor 14 is an annular combustor, any other type of combustor, such as a can combustor, can be provided. In an exemplary embodiment, the combustor 14 forms part of an auxiliary power unit for an aircraft or a propulsion system for an aircraft.

In the exemplary embodiment shown in FIG. 1, the combustor 14 includes an inner case 18 that extends annularly about a central axis 17 of the combustor 14 and an outer case 20 concentrically arranged with respect to the inner case 18. The inner and outer cases 18 and 20 define an annular pressure vessel 24. The combustor 14 further includes an inner liner 30 and an outer liner 28 circumscribing the inner liner 30 within the annular pressure vessel 24. The inner liner 30 is coupled to the inner case 18 at flange 70, and the outer liner 20 is coupled to the outer case 20 at flange 72. The outer liner 28 and the inner liner 30 define an annular combustion chamber 32. The outer and inner liners 28 and 30 also cooperate with outer and inner cases 18 and 20 to define respective outer and inner air passageways 34 and 36. The outer and inner liners 28, 30 can include any suitable material, such as HA230. Similarly, the inner and outer cases 18, 20 can include any suitable material, such as INCO718 and/or TI-6-2-4-2.

The combustor 14 includes a front-end assembly 38 having an annularly extending shroud 40, at least one fuel injector 44, and at least one fuel injector guide 46. One fuel injector 44 and one fuel injector guide 46 are shown in the partial cross-sectional view of FIG. 1, although it is appreciated that more fuel injectors and fuel injector guides may be disposed about central axis 17 in within the combustor 14. The fuel injector 44 may also be coupled with a secondary air swirler (not shown) as is typical practice in gas turbine combustors. The shroud 40 extends between and is secured to the forwardmost ends of the outer and inner liners 28 and 30. The shroud 40 includes at least one shroud port 48 that accommodates the fuel injector 44 and introduces air into the forward end of the combustion chamber 32. The fuel injector 44 is secured to the outer case 20 at flange 74 and projects through the shroud port 48. The fuel injector 44 introduces a swirling, intimately blended fuel-air mixture that supports combustion in the combustion chamber 32.

An igniter 62 extends through the outer case 20 and the outer passageway 34, and is coupled to the outer liner 28. Typically, the igniter is fixedly mounted to the outer case 20, and as described in further detail below, is movably coupled to the outer liner 28. More than one igniter 62 can be provided in the combustor 14, although only one is illustrated in FIG. 1. The igniter 62 is arranged downstream from the fuel injector 44 and is positioned to ignite a fuel and air mixture within the combustion chamber 32.

The igniter 62 is coupled to outer liner 28 by an igniter tube 64. More specifically, the igniter tube 64 is coupled within an opening 66 extending through outer liner 28, such that the igniter tube 64 is concentrically aligned with respect to the opening 66 of the outer liner 28. The igniter tube 64 maintains a sealing interface for the igniter 62 and the outer liner 28 such that the igniter 62 extends into the combustion chamber 32. In one embodiment, the opening 66 of the outer liner 28 and the igniter tube 64 have substantially circular cross-sectional profiles.

During engine operation, airflow exits a high pressure diffuser and deswirler 12 (partially shown) at a relatively high velocity and is directed into the annular pressure vessel 24 of the combustor 14. The airflow enters the combustion chamber 32 through openings in the outer and inner liners 28 and 30, where it is mixed with fuel from the fuel injector 44, and the airflow is combusted after being ignited by the igniter 62. The combusted air exits the combustion chamber 32 and is delivered to a turbine (not shown).

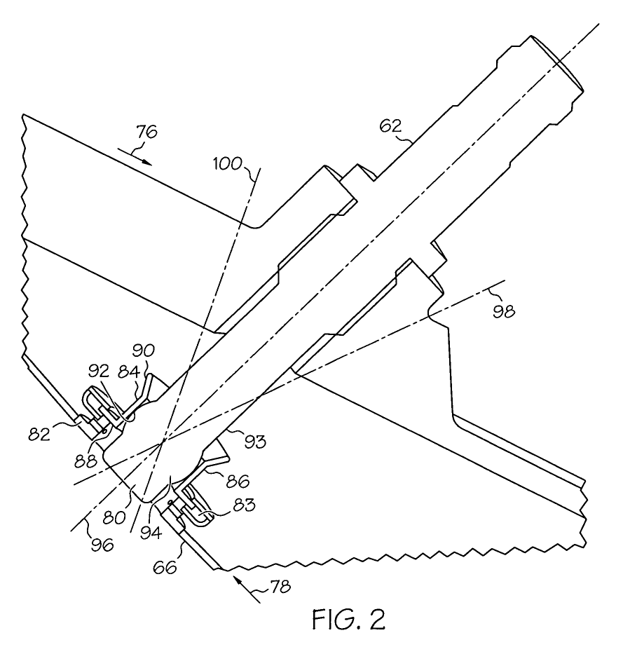

One of the issues encountered by the combustor 14 is the relative movement of the components resulting from thermal expansion during high temperature operations. Temperatures can range, for example, between −70° and 2000° F. As the temperatures within the combustor 14 increase, the outer case 20 undergoes thermal expansion. Since the outer case 20 is hard mounted to the fuel injector 44 at flange 74, the outer case 20 tends to expand in a direction away from flange 74, as indicated by arrow 76. Similarly, the outer liner 28 also undergoes thermal expansion as temperatures within the combustor 14 increase. Since the outer liner 28 is hard mounted at flange 72, the outer liner 28 tends to expand in a direction away from the flange 72, as indicated by the arrow 78. As noted above, the igniter 62 extends between and is coupled to both the outer case 20 and the outer liner 28. This pulls the igniter 62 in different directions (e.g., direction 76 and 78) as the outer case 20 and the outer liner 28 thermally expand. Moreover, since the outer case 20 is further removed from the combustion chamber 32 than the outer liner 28, the outer case 20 and the outer liner 28 also expand at different rates. As discussed in further detail below in reference to FIG. 2, the igniter 62 is mounted to accommodate for the relative movements of the outer case 20 and the outer liner 28.

FIG. 2 is an enlarged isometric cross-sectional view, represented by the dashed box 60 of FIG. 1, of the igniter 62 coupled to the igniter tube 64 on the outer liner 28 and the outer case 20. As noted above, the igniter tube 64 mounts the igniter 62 in the combustor 14, and particularly mounts the igniter 62 such that an end 80 of the igniter 62 is exposed to the fuel and air mixture in the combustion chamber 32. The end 80 may be slightly recessed, slightly protuding, or nominally flush with the inner surface of the outer liner 28.

The igniter tube 64 includes an igniter boss 82 and a grommet 84. The igniter boss 82 is mounted to the outer liner 28. Particularly, an outer diameter of the igniter boss 82 is approximately equal to a diameter of the opening 66 of the outer liner 28, and accordingly, the igniter boss 82 is received in close tolerance within opening 66 of the outer liner 28. In the exemplary embodiment, the igniter boss 82 has a substantially circular outer diameter corresponding to a diameter of the opening 66 of the outer liner 28. In an alternate embodiment, the igniter boss 82 is mounted onto an outer or inner surface of the outer liner 28. The igniter boss 82 has a slot 83 to receive the grommet 84, as discussed in further detail below.

The grommet 84 of the igniter tube 64 includes a receiving ring 86 coupled to an attaching ring 88, which extends radially substantially perpendicular from the receiving ring 86. The attaching ring 88 of the grommet 84 extends radially within the slot 83 of the igniter boss 82. As a result of this arrangement, the grommet 84 is able to have some lateral movement with respect to the igniter boss 82 to accommodate some manufacturing tolerances and movements during operation. In an alternate embodiment, the grommet 84 is fixed to the igniter boss 82 and not movable laterally.

As noted above, the receiving ring 86 is coupled to the igniter 62. The receiving ring 86 includes a radially divergent portion 90 that guides the igniter 62 into contact with a substantially cylindrical wall portion 92. The wall portion 92 forms a sealing interface with the igniter 62.

The igniter 62 generally includes a cylindrical body 93 and a protrusion 94 that is adjacent the end 80. In one embodiment, protrusion 94 is spherical and extends from the cylindrical body 93 to mate with the wall portion 92 of the receiving ring 86 of the igniter tube 64. Although the protrusion 94 is described as spherical, other configurations or shapes can be provided. The protrusion 94 can be semi-spherical, oblate-spheroid, and/or include straight, irregular, or omitted portions. The protrusion 94 can have any diameter larger than the diameter of adjacent portions of the body 93 of the igniter 62.

Due to the geometry of the protrusion 94, the igniter 62 has the ability to rotate or pivot at the protrusion 94 as a result of movements of the outer case 20 and the outer liner 28. For example, the longitudinal axis 96 of the igniter 62 prior to operation, or at the beginning of operation, is shown in FIG. 2. As noted above, as temperatures rise during operation, the outer case 20 expands in direction 76 and the outer liner 28 expands in the opposite direction 78. The igniter 62 is fixedly mounted to and moves with the outer case 20. The protrusion 94 enables the igniter 62 to pivot relative to the outer liner 28 such as to an extent shown by the axis 98. Alternately, the igniter 62 can pivot as shown by the axis 100. Accordingly, the pivoting igniter 62 accommodates the relative movement of the outer liner 28 and outer case 20 while maintaining a sealing interface with the igniter tube 64. Any ratio of the protrusion diameter to the igniter body diameter suitable for a desired rotation or pivot can be provided. The igniter 62 can be pivoted to any desired angle, such as, for example, 0.25°-30°. In one embodiment, the igniter 62 can pivot 16°.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A combustor for a gas turbine engine, comprising:
an inner case;
an outer case circumscribing the inner case and forming an annular pressure vessel therebetween;
an inner liner positioned within the annular pressure vessel;
an outer liner circumscribing the inner liner and forming a combustion chamber with the inner liner; and
an igniter coupled to the outer case and extending to the outer liner such that the igniter is positioned to ignite an air and fuel mixture in the combustion chamber, the igniter comprising a protrusion for coupling the igniter to the outer liner.

2. The combustor of claim 1, wherein the protrusion is spherical.

3. The combustor of claim 1, wherein the protrusion enables the igniter to pivot relative to the outer liner.

4. The combustor of claim 1, wherein, during operation, the outer case thermally expands in a first direction and the outer liner thermally expands in a second direction such that the igniter pivots relative to the outer liner at the protrusion.

5. The combustor of claim 1, wherein, prior to operation, the igniter has a first position and, during operation, the igniter pivots at the protrusion into a second position, the second position being at least 0.25° relative to the first position.

6. The combustor of claim 1, further comprising an igniter tube coupling the igniter to the outer liner.

7. The combustor of claim 1, wherein the igniter has a cylindrical portion adjacent the protrusion, the cylindrical portion having a first diameter and the protrusion having a second diameter.

8. The combustor of claim 1, wherein the igniter has an end portion and the protrusion is adjacent the end portion.

9. The combustor of claim 1, wherein the igniter tube includes an igniter boss mounted on the outer liner and a grommet coupled to the protrusion, the grommet being movable in a lateral direction to the igniter boss.

10. The combustor of claim 1, wherein the igniter is fixedly mounted to the outer case and movably mounted to the outer liner.

11. The combustor of claim 1, wherein the protrusion forms a sealing interface with the outer liner.

12. The combustor of claim 1, wherein the protrusion forms a sealing interface with the igniter tube.

13. The combustor of claim 1, wherein the igniter is configured to pivot in at least two directions.

14. An igniter assembly for igniting an air and fuel mixture in a combustion chamber of a combustor, comprising:
an igniter tube configured to be mounted on a liner of the combustion chamber; and
an igniter comprising
a generally cylindrical body having a first end and a second end, and
a protrusion extending from the cylindrical body adjacent the first end and coupled to the igniter tube.

15. The igniter assembly of claim 14, wherein the protrusion is spherical.

16. The igniter assembly of claim 14, wherein the protrusion enables the igniter to pivot relative to the liner.

17. The igniter assembly of claim 14, wherein the cylindrical body has a first diameter and the protrusion has a second diameter.

18. The igniter assembly of claim 14, wherein the igniter tube includes an igniter boss to be mounted on the liner and a grommet being coupled to the protrusion, the grommet movable in a lateral direction to the igniter boss.

19. The igniter assembly of claim 14, wherein the protrusion forms a sealing interface with the igniter tube.

20. A combustor for a gas turbine engine, comprising:
an inner case;
an outer case circumscribing the inner case and forming an annular pressure vessel therebetween, the outer case thermally expanding in a first direction during operation;
an inner liner positioned within the annular pressure vessel;
an outer liner circumscribing the inner liner and forming a combustion chamber with the inner liner, the outer liner thermally expanding in a second direction during operation; and
an igniter for igniting an air and fuel mixture in the combustion chamber, the igniter having body coupled to the outer case and extending to the outer liner, the igniter further including a cylindrical protrusion extending from the body and coupled to the outer liner such that the igniter pivots at the protrusion when the outer case moves in a first direction and the inner case moves in the second direction.
